(19) United States
(12) Patent Application Publication
(10) Pub. No.: US 2016/0339654 A1
(43) Pub. Date: Nov. 24, 2016

(54) METHOD AND MOLD FOR FABRICATING CONTACT LENS AND CONTROLLING EXCESS MATERIAL AND METHOD FOR FABRICATING THE SAME MOLD

(71) Applicant: UNICON OPTICAL CO., LTD., HSINCHU COUNTY 30075 (TW)

(72) Inventors: SHIH-HONG CHU, HSINCHU COUNTY 30075 (TW); YUNG-CHIH LIU, HSINCHU COUNTY 30075 (TW)

(21) Appl. No.: 15/152,892

(22) Filed: May 12, 2016

(30) Foreign Application Priority Data
May 22, 2015 (TW) 104116443

(51) Int. Cl. B29D 11/00; B29C 33/42; B29C 45/00; B29C 33/00

(52) U.S. Cl. CPC B29D 11/00038; B29C 33/0055; B29C 33/42; B29C 45/0053; B29D 11/00134; B29D 11/00192; B29K 2105/0058

(57) ABSTRACT

The present invention discloses a method and mold for fabricating a contact lens and controlling excess material and a method for fabricating the same mold and comprises steps: fabricating a first mold having a mold cavity and a side wall formed around the rim of the mold cavity and having protuberances, fabricating a second mold having a round protrusion; using a disc-shape cutter to cut the side wall and protuberances and form a groove; placing a liquid contact lens material in the mold cavity; matching the round protrusion with the mold cavity to make the liquid contact lens material have a spherical shell shape with the curvature of the round protrusion and make the residual material flow to the groove and between two protuberances. Thereby, all the excess material are attached to the first mold and separated together with the first mold from the second mold in demolding.

This application claims priority for Taiwan patent application no. 104116443 filed on May 22, 2015, the content of which is incorporated by reference in its entirely.

### BACKGROUND OF THE INVENTION

1. Field of the Invention

The present invention relates to a technology for controlling the excess material of a contact lens, particularly to a method and mold for fabricating a contact lens and controlling excess material and a method for fabricating the same mold.

2. Description of the Related Art

Many people suffer from vision damage or vision degeneration, such as myopia. People who suffer myopia usually wear glasses or contact lenses to resume normal vision. Contact lenses are more convenient and comfortable than glasses and a better choice for some people.

Contact lenses are normally fabricated with casting methods. In casting methods, a liquid contact lens material is injected into the mold cavity of a plastic lower mold; the protrusion portion of a plastic upper mold is placed in the mold cavity; the upper mold and the lower mold are pressed with pressure to form the liquid contact lens material between the upper mold and the lower mold to have the shape required by a contact lens; the liquid contact lens material together with the upper and lower molds are treated with high temperature or ultraviolet light to polymerize the liquid contact lens material to a solid state; then the upper and lower molds are separated to obtain a solid-state contact lens. However, the normal mold lacks a structure to grasp the excess material existing in the excess material area outside the mold cavity. The excess material and the debris thereof are likely to remain on and contaminate the contact lens. Thus, the contaminated contact lenses need cleaning manually in the succeeding process. Further, the excess material and the debris thereof are likely to interfere with automatic vision inspection equipment and cause it to misjudge a lot of qualified products as unqualified products. Consequently, the contact lenses cannot be screened automatically but can only be inspected manually. Thus, much time and manpower is consumed. Accordingly, the present invention proposes a method and mold for fabricating a contact lens and controlling excess material and a method for fabricating the same mold to overcome the abovementioned problems.

### SUMMARY OF THE INVENTION

The primary objective of the present invention is to provide a method and mold for fabricating a contact lens and controlling excess material and a method for fabricating the same mold, wherein the cured excess material of a contact lens is attached to groove and between two protuberances of a first mold, whereby the excess material is stripped off and abandoned together with the first mold in demolding, and whereby a clean and pollution-free contact lens is obtained, wherefore the cost and time the conventional technology spends in cleaning excess material and contact lenses is saved, and wherefore the efficiency and yield is greatly increased.

Another objective of the present invention is to provide a method and mold for fabricating a contact lens and controlling excess material and a method for fabricating the same mold, which can exempt the automatic contact lens inspection equipment from being interfered with by excess material, whereby the accuracy of automatic contact lens inspection is promoted.

To achieve the abovementioned objectives, the present invention proposes a method for fabricating a contact lens and controlling excess material, which comprises steps: providing a first mold and a second mold, wherein the first mold has a mold cavity, and wherein a side wall with a plurality of protuberances is disposed around the rim of the mold cavity, and wherein a groove is annularly formed on the side wall and transversely passes the protuberances, and wherein the second mold has a round protrusion; placing a liquid contact lens material in the mold cavity; matching the second mold with the first mold and pressing the round protrusion into the mold cavity with pressure to make the liquid contact lens material have a spherical shell shape with the curvature of the round protrusion and make the residual liquid contact lens material overflow to the groove and between two protuberances.

The present invention also proposes a contact lens mold, which comprises a first mold having a mold cavity and a side wall formed around the rim of the mold cavity, wherein the side wall has a plurality of protuberances, and wherein a groove is annularly formed on the side wall and transversely passes the protuberances; and a second mold having a round protrusion matching the mold cavity.

The present invention further proposes a method for fabricating a contact lens mold, which comprises steps: fabricating a first mold and a second mold, wherein the first mold has a mold cavity and a side wall formed around the rim of the mold cavity, and wherein the side wall has a plurality of protuberances, and wherein the second mold has a round protrusion; using a disc-shape cutter to cut the side wall and protuberances of the first mold and using a support seat to drive the first mold to rotate in a direction identical to the rotation direction of the disc-shape cutter to annularly form a groove on the side wall and the protuberances.

Below, embodiments are described in detail to make easily understood the objectives, technical contents, characteristics and accomplishments of the present invention.

### BRIEF DESCRIPTION OF THE DRAWINGS

FIG. 1 is a perspective view schematically showing a contact lens mold according to one embodiment of the present invention;

FIG. 2 is a sectional view schematically showing a contact lens mold according to one embodiment of the present invention;

FIG. 3 shows a flowchart of a method for fabricating a contact lens mold according to one embodiment of the present invention;

FIG. 4a and FIG. 4b are diagrams schematically showing the process of cutting a groove according to one embodiment of the present invention;

FIG. 5 shows a flowchart of a method for fabricating a contact lens according to one embodiment of the present invention; and

FIG. 6 is a diagram schematically showing that a contact lens is separated from a second mold according to one embodiment of the present invention.

### DETAILED DESCRIPTION OF THE INVENTION

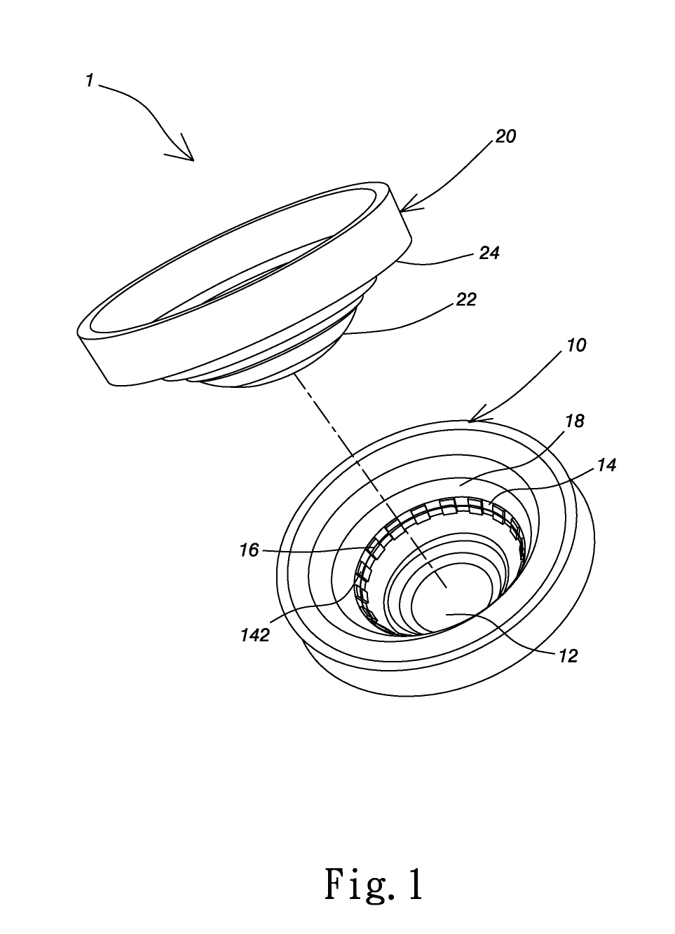

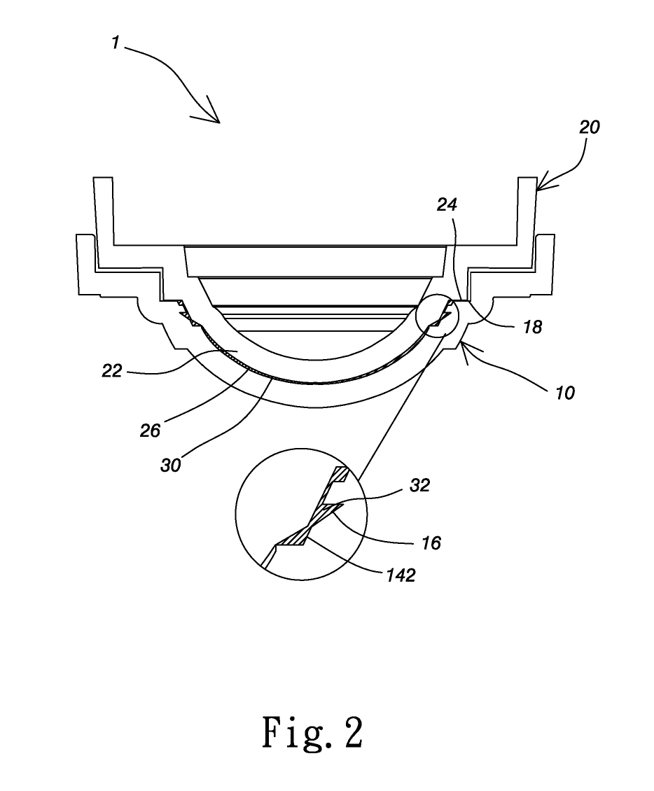

Refer to FIG. 1 and FIG. 2. In the present invention, the contact lens mold 1 comprises a first mold 10 and a second mold 20. The first mold 10 is made of a metallic material or a plastic material. The first mold 10 has a mold cavity 12. A side wall 14 is disposed around the rim of the mold cavity 12. A plurality of protuberances 142 is annularly disposed on the side wall 14. A V-shape cross section groove 16 is disposed on the side wall 12 annularly and passes through the protuberances 142 transversely. A support member 18 extends vertically from the side wall 14. The second mold 20 is made of a metallic material or a plastic material. The second mold 20 has a round protrusion 22 matching the mold cavity 12 of the first mold 10. An assembly member 24 is disposed around the rim of the round protrusion 22. While the round protrusion 22 of the second mold 20 is pressed down to match the mold cavity 12 of the first mold 10, the assembly member 24 is pressed against the support member 18 of the first mold 10 with a contact lens forming space 26 existing between the round protrusion 22 and the mold cavity 12. The surface of the round protrusion 22 is treated to have hydrophilicity, whereby a contact lens 30 can adhere to the surface of the round protrusion 22 after the contact lens 30 is cured.

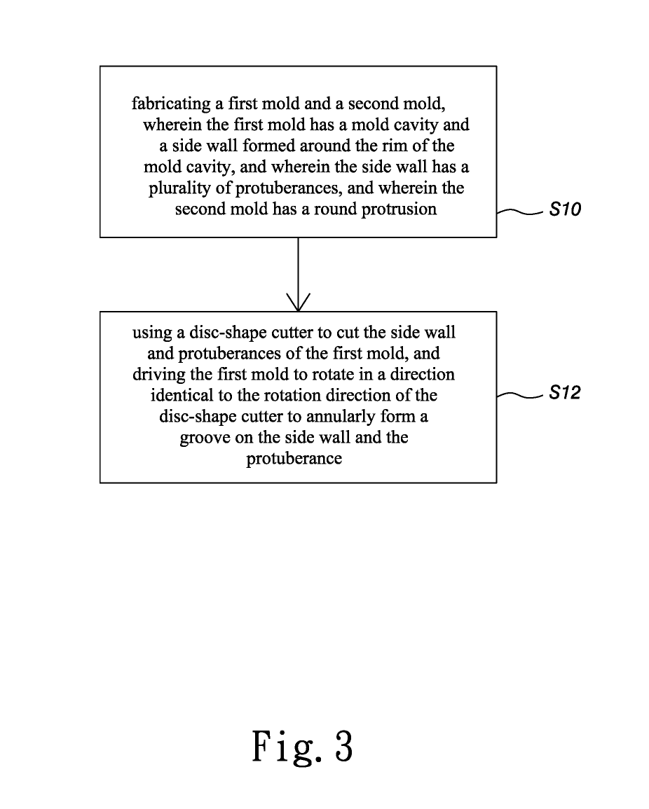

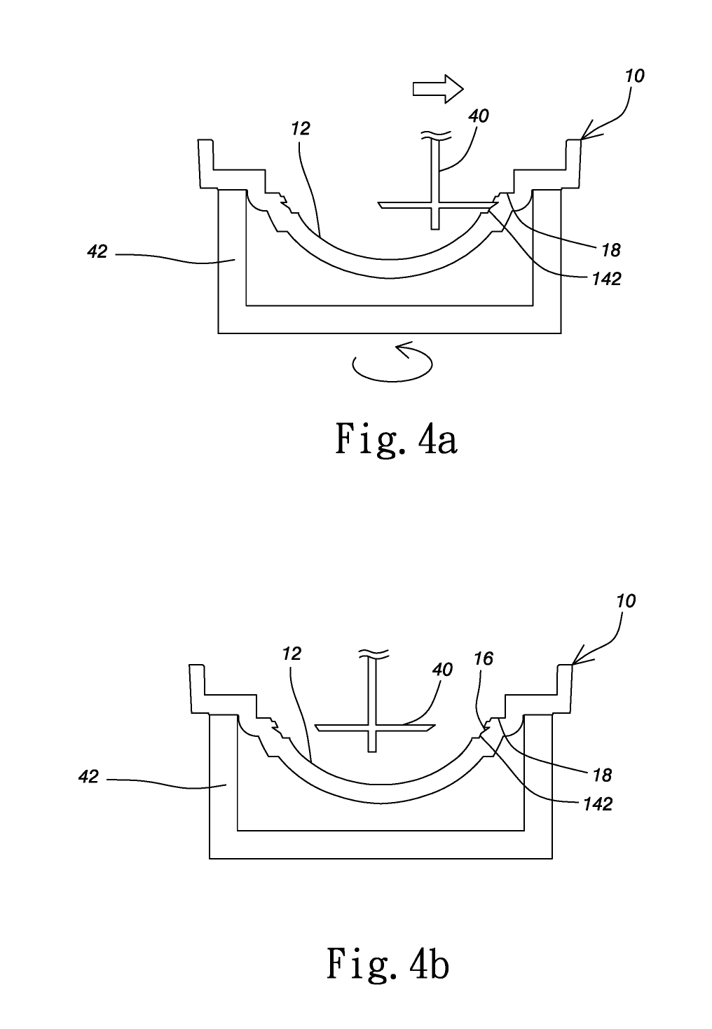

Refer to FIG. 1 and FIG. 3. After the structure of the contact lens mold 1 has been described above, a method for fabricating the contact lens mold 1 will be described below. In Step S10, fabricate a first mold 10 and a second mold 20 with an injection-molding method. After injection-molding, the first mold 10 has a mold cavity 12, a side wall 14 disposed around the rim of the mold cavity 12, a plurality of protuberances 142 annularly disposed on the side wall 14, and a support member 18 extending from the side wall 14. After injection-molding, the second mold 20 has a round protrusion 22 and an assembly member 24 disposed around the rim of the round protrusion 22. The surface of the round protrusion 22 is treated to have hydrophilicity with a corona process, a flaming process or a short-wavelength ultraviolet process. Refer to FIG. 4a._In Step S12, use a disc-shape cutter 40 to cut the side wall 14 and the protuberances 142 of the first mold 10, wherein a support seat 42 drives the first mold 10 to rotate in a direction identical to the rotation direction of the disc-shape cutter 40. Refer to FIG. 4b. The disc-shape cutter 40 annularly cuts the side wall 14 and the protuberances 142 of the first mold 10 to form a groove 16. As the blade of the disc-shape cutter 40 has a V-shape cross section, the groove 16 is a V-shape cross section groove.

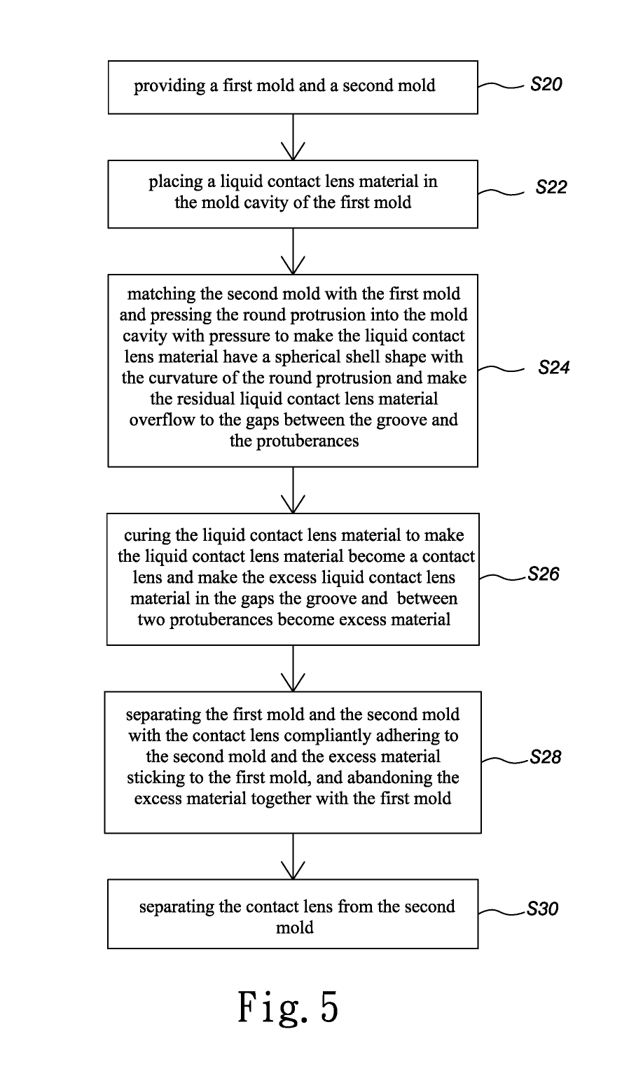

Refer to FIG. 1, FIG. 2 and FIG. 5. After the structure of the contact lens mold 1 and the method for fabricating the contact lens mold 1 have been described above, a method of using the contact lens mold 1 to fabricate a contact lens 30 is described below. In Step S20, provide a first mold 10 and a second mold 20. The structures of the first mold 10 and the second mold 20 are the same as those described above and will not repeat herein. In Step S22, place a liquid contact lens material in the mold cavity 12 of the first mold 10. Refer to FIG. 2. In the Step S24, match the second mold 20 with the first mold 10 with pressure to the assembly member 24 of the second mold 20 against the support member 18 of the first mold 10 and place the round protrusion 22 in the mold cavity 12 so as to generate a contact lens forming space 26 between the round protrusion 22 and the mold cavity 12. Thus, the liquid contact lens material has a spherical shell shape, and two surfaces thereof respectively have the curvatures of the mold cavity 12 and the round protrusion 22. Simultaneously, the excess liquid contact lens material is extruded out and flows to the groove 16 and between two protuberances 142. Thereby, the liquid contact lens material extends to the groove 16 and between two protuberances 142.

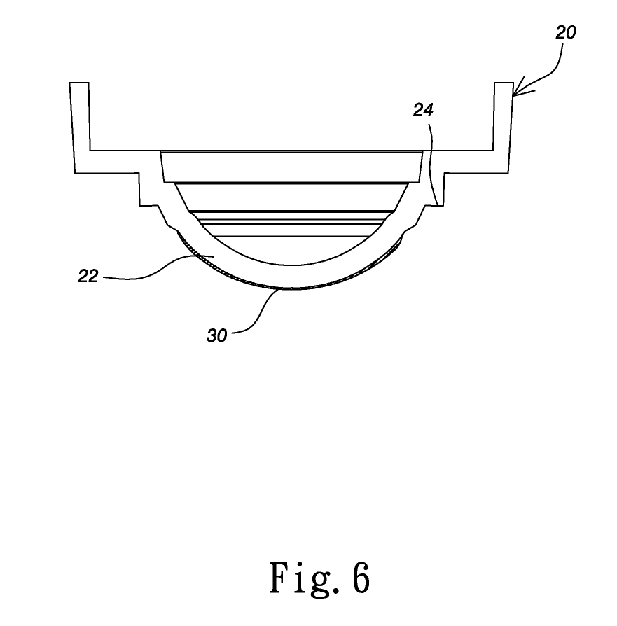

In the Step S26, cure the liquid contact lens material with a curing process to make the liquid contact lens material in the contact lens forming space 26 become a contact lens 30 and make the excess liquid contact lens material in the groove 16 and between two protuberances 142 become excess material 32. The curing process is a light curing process or a thermal curing process. The light curing process uses an ultraviolet lamp to illuminate the liquid contact lens material to form the contact lens 30 and the excess material 32. The thermal curing process uses hot air from a hot air chamber to heat the liquid contact lens material to form the contact lens 30 and the excess material 32. After the contact lens 30 and the excess material 32 have been formed, the process proceeds to Step S28. In Step S28, separate the first mold 10 from the second mold 20. Refer to FIG. 6. As the surface of the round protrusion 22 of the second mold 20 is treated to have hydrophilicity, the contact lens 30 will compliantly adhere to the round protrusion 22 of the second mold 20 while the first mold 10 is separated from the second mold 20. Meanwhile, the excess material 32 sticks to the groove 16 and the protuberances 142 of the first mold 10, and the excess material 32 is abandoned together with the first mold 10. Next, the process proceeds to Step S30. In Step S30, separate the cured contact lens 30 from the second mold 20. Then, the contact lenses 30 are packaged for sale.

Thereby, the groove 16 and the protuberances 142 can fully hold the liquid contact lens material and enable the excess material 32 together with the first mold 10 to be separated from the second mold 20 and the contact lens 30. Therefore, the method and mold of the present invention effectively prevents the debris of the excess material 30 from falling on the contact lens 30, increasing the efficiency of fabrication and package and favoring fabrication automation.

In conclusion, the present invention attaches all the cured excess material to the groove and the protuberances of the first mold and enables all the excess material together with the first mold to be separated from the contact lens and the second mold without any excess material adhering to the contact lens. Therefore, the present invention can acquire clean and contamination-free contact lenses, saves the time and cost the conventional technology spends in cleaning excess material in the rear stage, greatly promotes the efficiency and yield, and facilitates automatic fabrication of contact lenses. As the present invention prevents excess material from adhering to contact lenses, the automatic contact lens inspection equipment would not detect any excess material adhering to the contact lenses. Therefore, the manufacturer is free from cleaning contact lenses manually in the succeeding process and exempt from the interference on fabrication automation and fabrication efficiency.

The embodiments described above are only to exemplify the present invention but not to limit the scope of the present invention. Any equivalent modification or variation according to the characteristic or spirit of the present invention is to be also included within the scope of the present invention.

What is claimed is:

1. A method for fabricating a contact lens and controlling excess material thereof, comprising steps:
providing a first mold and a second mold, wherein said first mold has a mold cavity, and wherein a side wall is formed around a rim of said mold cavity, and wherein said side wall has a plurality of protuberances, and wherein a groove is annularly formed on said side wall and transversely passes said protuberances, and wherein said second mold has a round protrusion;
placing a liquid contact lens material in said mold cavity of said first mold; and
matching said second mold with said first mold to place said round protrusion inside said mold cavity, and pressing down said second mold to make said liquid contact lens material have a spherical shell shape and extrude residual said liquid contact lens material to said groove and between two said protuberances.

2. The method for fabricating a contact lens and controlling excess material thereof according to claim 1 further comprising a curing step:
curing said liquid contact lens material into a contact lens and curing residual said contact lens material in said groove and between two said protuberances into excess material.

3. The method for fabricating a contact lens and controlling excess material thereof according to claim 2 further comprising a step of separating said first mold and said second mold, wherein after said first mold and said second mold are separated, said contact lens compliantly adheres to said second mold, and said excess material adheres to said groove and between two said protuberances, and wherein said excess material is abandoned together with said first mold.

4. The method for fabricating a contact lens and controlling excess material thereof according to claim 3 further comprising a step of separating said contact lens and said second mold.

5. The method for fabricating a contact lens and controlling excess material thereof according to claim 1, wherein a surface of said round protrusion of said second mold is treated to have hydrophilicity.

6. The method for fabricating a contact lens and controlling excess material thereof according to claim 2, wherein said curing step is realized with a light curing method or a thermal curing method.

7. The method for fabricating a contact lens and controlling excess material thereof according to claim 1, wherein said first mold and said second mold are metallic molds.

8. The method for fabricating a contact lens and controlling excess material thereof according to claim 1, wherein said first mold and said second mold are plastic molds.

9. A contact lens mold comprising
a first mold having a mold cavity, wherein a side wall is formed around a rim of said mold cavity, and wherein said side wall has a plurality of protuberances, and wherein a groove is annularly formed on said side wall and transversely passes said protuberances; and
a second mold having a round protrusion matching said mold cavity of said first mold.

10. The contact lens mold according to claim 9, wherein a surface of said round protrusion of said second mold is treated to have hydrophilicity.

11. The contact lens mold according to claim 9, wherein said groove is a V-shape cross section groove.

12. The contact lens mold according to claim 9, wherein said side wall of said first mold has a support member extending vertically from said side wall, and wherein an assembly member is formed around a rim of said round protrusion, and wherein while said round protrusion is lowered to match said mold cavity, said assembly member is positioned on said support member with a contact lens forming space created between said round protrusion and said mold cavity.

13. The contact lens mold according to claim 9, wherein said first mold and said second mold are metallic molds.

14. The contact lens mold according to claim 9, wherein said first mold and said second mold are plastic molds.

15. A method for fabricating a contact lens mold, comprising steps:
fabricating a first mold and a second mold, wherein said first mold has a mold cavity and a side wall formed around a rim of said mold cavity, and wherein said side wall has a plurality of protuberances, and wherein said second mold has a round protrusion; and
using a disc-shape cutter to cut said side wall and said protuberances of said first mold, wherein a support seat drives said first mold to rotate in a direction identical to a rotation direction of said disc-shape cutter and let said disc-shape cutter annularly cuts said side wall and said protuberances to form said groove.

16. The method for fabricating a contact lens mold according to claim 15 further comprising a step of treating a surface of said round protrusion to have hydrophilicity with a corona method or a short-wavelength ultraviolet method.

17. The method for fabricating a contact lens mold according to claim 15, wherein said disc-shape cutter has a V-shape cross section blade to make said groove a V-shape cross section groove.

18. The method for fabricating a contact lens mold according to claim 15, wherein said first mold and said second mold are fabricated with an injection-molding method.

19. The method for fabricating a contact lens mold according to claim 15, wherein said first mold and said second mold are metallic molds.

20. The method for fabricating a contact lens mold according to claim 15, wherein said first mold and said second mold are plastic molds.
